(19) United States
(12) Patent Application Publication
(10) Pub. No.: US 2002/0098930 A1
(43) Pub. Date: Jul. 25, 2002

(54) System for the transmission of motion to a winch for sailboats through a pedestal

(75) Inventors: Andrea Merello, Genova (IT); Alberto Lozza, Cornaredo (MI) (IT); Luciano Bonassi, Saronno (VA) (IT)

Correspondence Address: Russell W. Pyle, Pyle & Piontek, Suite 850, 221 N. LaSalle St., Chicago, IL, 60601, US

(73) Assignee: Harken-Italy, Lurago Marinone (CO) (IT)

(21) Appl. No.: 09/769,682

(22) Filed: Jan. 25, 2001

(51) Int. Cl. F16H 7/00; B66D 3/16; B63B 21/04

(52) U.S. Cl. 474/62; 254/359; 114/218; 474/68; 474/156

(57) ABSTRACT

A system for the transmission of motion to a winch for sailboats, in particular for racing and/or cruising sailboats, comprises first belt transmission means housed inside a pedestal and second belt transmission means between the pedestal and a winch. The transmission system comprises in particular a drive pulley housed in the pedestal, a driven pulley intended to be coaxially mounted onto the primary rotational shaft of the winch, a single belt between the drive pulley and the driven pulley and a pair of motion deviation pulleys between the drive pulley and the driven pulley. The transmission system thus provide for the use of a single belt and a plurality of pulleys; this allows to remarkably reduce the manufacturing costs of the system and simplify its assembly operations onto the boat.

The present invention relates to a system for the transmission of motion to a winch for sailboats through a pedestal. The transmission system according to the invention has a preferred but not exclusive application in racing and/or cruising sailboats of medium-big size.

As known, winches are used on sailboats to facilitate the manoeuvring and trimming of sails carrying a load, such as for example the operations for positioning and hoisting the sails. Said operations are carried out by manoeuvring suitable ropes (commonly referred to also with the terms: sheets or halyard) suitably connected to the sails; the ropes, in particular, are pulled by winding the same on proper winches suitably arranged on the deck of the boat.

The traction is applied to the rope by imparting a rotation to the primary shaft of the winch; such rotation may be imparted by one or more crew members through different transmission systems which are alternative to each other.

One of such systems provides for the use of a pedestal located onto the boat at a remote position with respect to the winch and of a series of components and accessories adapted to transmit the motion from the pedestal to the winch. Such system is typically used for controlling medium large-sized racing and/or cruising sailboats, where it is necessary to guarantee that they are executed in a fast and powerful way; according to the such system, one or more crew members may activate the winch while being in a standing position, such position being more comfortable and allowing more power to be provided.

The pedestals usually employed in sailboats of the above mentioned type are belt transmission pedestals, which are usually manufactured in carbon fibre or fibreglass. They comprise a drive pulley housed at an upper end of the pedestal, a driven pulley housed at a lower end of the pedestal and a transmission belt between the drive pulley and the driven pulley. Onto the lower pulley a clutch or a joint is mounted fixed, intended for receiving an end of a motion deviation shaft to the winch; the other end of such shaft is instead intended to be connected through a second clutch or joint with a 90° conical gear housed within a suitable box located below the winch and adapted to deviate the motion to the primary shaft thereof.

A drawback connected to the motion transmission systems through pedestals as above described is correlated to their high cost of manufacturing and the high production complexity of some of the components employed, such as for example the conical gear for 90° motion deviation.

It is known that the manufacturing and assembling of a conical gear requires a high degree of precision, in order to guarantee a relatively long lifetime and high motion transmission yields in operation. This inevitably influences the production and sale cost of the same, and hence, the cost of the overall motion transmission system.

Furthermore, the presence of a plurality of components and accessories (clutches, joints, motion deviation shafts, conical gear), intended for co-operating with each other, makes it necessary to have particular care in choosing the components themselves in the assembly and maintenance operations thereof.

The technical problem at the basis of the present invention is that of providing a motion transmission system to a winch through pedestal, which is simple as far as its construction is concerned, economic, reliable and functional, thus overcoming the drawbacks above mentioned with reference to the prior art.

Therefore, in a first aspect thereof, the invention relates to a system for the transmission of motion to a winch for sailboats through a pedestal, comprising:

a drive pulley housed in a pedestal and having an X-X rotational axis;

a driven pulley intended to be coaxially mounted onto a primary rotational shaft of a winch;

a single belt between the drive pulley and the driven pulley;

motion deviation means between the drive pulley and the driven pulley.

The present invention hence provides a system in which the overall motion transmission between the pedestal and the winch is carried out through a single belt.

Advantageously, the use of such a motion transmission system allows not to use a motion deviation shaft between the pedestal and the winch and a 90° conical gear for motion transmission from the motion deviation shaft to the winch. The transmission system according to the invention is therefore simpler from the constructive point of view, and more economical than the ones above described with reference to the prior art. Furthermore, with respect to the above ones, it allows achieving the following further advantages, the transmission yield being the same: noiselessness, flexibility, assembly easiness and absence of lubrication. Even the possible ordinary and extraordinary maintenance operations, ashore or during sailing, are remarkably simplified, this being due above all to the absence of the conical gear.

Preferably, the motion deviation means is housed in the pedestal at a supporting base thereof. Still more preferably, the motion deviation means comprises a pair of motion deviation pulleys intended to direct the belt towards the driven pulley and the drive pulley, respectively. Both motion deviation pulleys are intended for rotating in opposite directions; in particular, the one receives the belt exiting from the drive pulley and directs it to the driven pulley, whereas the other one receives the belt exiting from the driven pulley and directs it to the drive pulley.

In a first embodiment of the transmission system according to the present invention, the pulleys of said pair of motion deviation pulleys are coaxial and have an Y-Y rotational axis which is substantially perpendicular to the X-X axis. This allows transmitting the motion to winches located on the boat along the X-X direction, that is to say, aligned with the pedestal with respect to the aft or the fore of the boat.

In a second embodiment of the motion transmission system according to the present invention, the pulleys of said pair of motion deviation pulleys have parallel rotational axes which are tilted by a predetermined angle other than 90° with respect the X-X axis. In this way it is possible to transmit the motion to winches located closer to the fore or aft of the boat with respect to the pedestal.

Preferably, said single belt is a cog belt made of plastic material with reinforcing fibres.

In a second aspect thereof, the invention relates to a system for the transmission of motion to a winch for sailboats through a pedestal, comprising first belt transmission means housed in a pedestal, characterised in that it comprises second belt transmission means between the pedestal and a winch, wherein said second belt transmission means is operatively connected to said first belt transmission means. According to a first embodiment of the second aspect of the motion transmission system according to the present invention, the first belt transmission means comprises:

a drive pulley having an X-X rotational axis;

a service pulley, intended to deviate the motion towards the winch;

a first belt between the drive pulley and the service pulley,

and wherein said second belt transmission means comprises:

said service pulley;

a driven pulley intended to be coaxially mounted onto a winch primary rotational shaft;

a second belt between the service pulley and the driven pulley.

In such embodiment, the motion transmission takes place through the use of two different belts, the one intended for transmitting the motion inside the pedestal and the other one intended for transmitting the motion from the pedestal to the driven pulley.

According to the preferred embodiment of the motion transmission system according to the present invention, said first and second belts are parts of a single belt. The overall motion transmission is therefore preferably carried out through a single belt (i.e. through the same transmission belt employed within the pedestal).

Anyway, in all the embodiments above described, the motion transmission requires, advantageously, the use of mechanical components and accessories (pulleys and belt) which are as a matter of common knowledge easier and more economical than the ones used in the motion transmission systems of the prior art (deviation shaft, joints and conical gear).

In a third aspect thereof, the present invention relates to a system for the transmission of motion to two winches through a single pedestal, comprising:

a pair of drive pulleys coaxially housed in a pedestal along a X-X rotational axis;

a pair of driven pulleys, each one intended to be located onto the boat on opposite sides with respect to the pedestal and coaxially to a winch primary rotational shaft;

a single belt between each drive pulley and each driven pulley;

motion deviation means between each drive pulley and each driven pulley.

Further features and advantages of the present invention will be better clear from the following detailed description of a preferred embodiment thereof, made with reference to the attached drawings.

In such drawings:

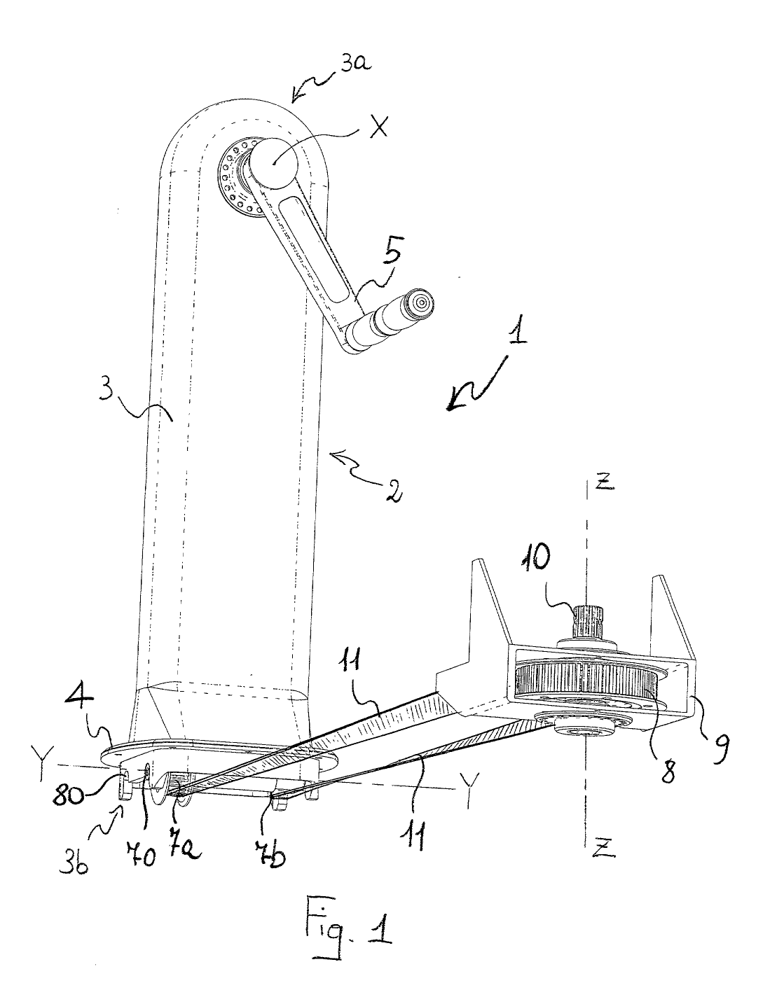

FIG. 1 shows a schematic perspective view of a motion transmission system according to the present invention;

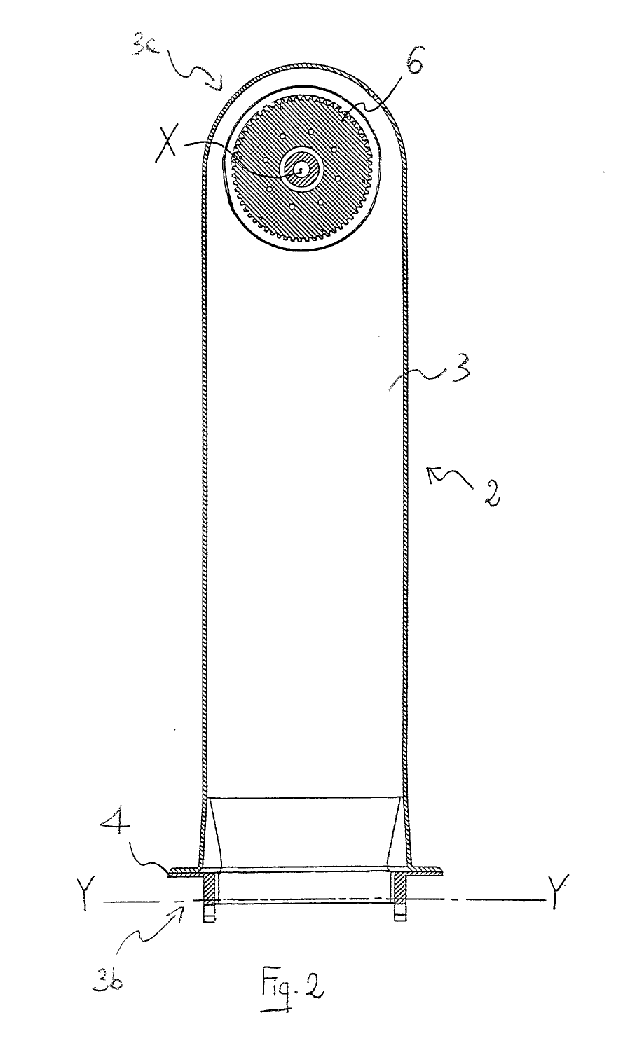

FIG. 2 shows an elevation schematic and partially sectioned view of the pedestal of the motion transmission system of FIG. 1;

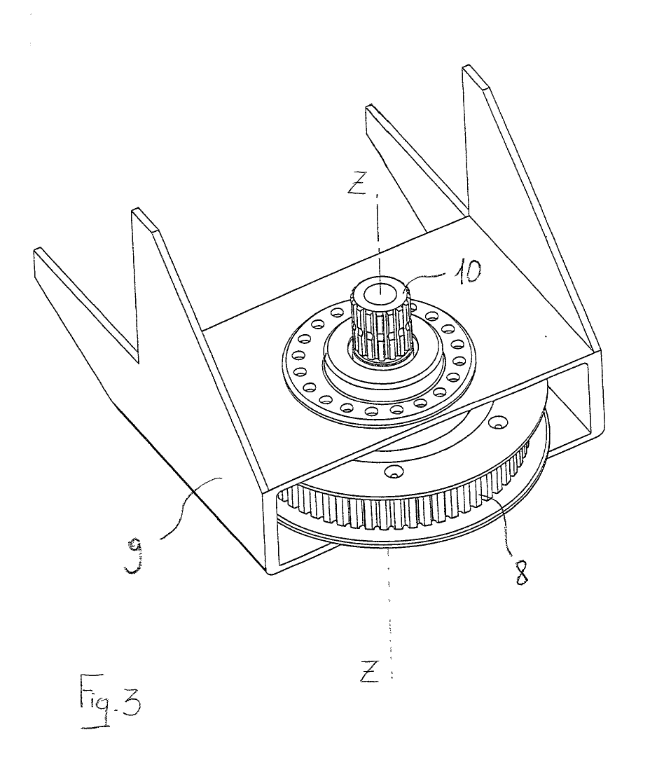

FIG. 3 shows a perspective view of a detail of the motion transmission system of FIG. 1.

In such figures, a system for the transmission of motion to a winch through a pedestal according to the present invention is indicated with 1.

The system 1 comprises a pedestal 2 intended to be mounted onto the boat in substantially vertical position. The pedestal comprises a streamlined body 3, made of carbon fibre or fibreglass equipped with a supporting base 4 intended to be fastened fixed onto the deck of the boat in remote position with respect to a (not shown) winch.

The body 3 comprises, at an upper end 3a thereof, a pair of handles 5 (of conventional type, whereby only one is visible) pivoted on the body 3 along a X-X rotational axis. Inside the body 3, along the X-X rotational axis and fixed to the handles 5, a drive pulley 6 is provide for transmitting the rotational motion imparted by the crew member(s) through the handles 5.

Furthermore, the body 3 comprises, at a lower end 3b thereof, a pair 7a, 7b of motion deviation pulleys coaxially mounted along a Y-Y rotational axis which is perpendicular to the X-X axis and extending below the supporting base 4. The pulleys 7a, 7b are idle onto a shaft 70 housed within suitable seats 80 formed onto the supporting base 4; alternatively, the pulleys 7a and 7b may be fixed to the shaft 70, which will be then associated to the base 4 through the interposition of suitable roller bearing.

The motion transmission system 1 of the invention comprises moreover a driven pulley 8 housed within a supporting structure 9 intended to be located below the deck of the boat, at the location where the winch is foreseen to be placed. The driven pulley 8 is mounted along a Z-Z rotational axis perpendicularly to both the X-X axis and the Y-Y axis and substantially coinciding with the winch rotational axis. A clutch 10 (of conventional type) is mounted fixed onto the pulley 8; the clutch 10 is intended for receiving the winch primary shaft (or an intermediate motion deviation shaft). The drive pulley 6, the motion deviation pulleys 7a, 7b and the driven pulley 8 are all toothed pulleys of conventional type and, accordingly, will not be described in detail.

The drive pulley 6 and the driven pulley 8 are connected through a single motion transmission belt 11. Such belt is a cog belt of a in se conventional type, preferably made of plastic material with supporting fibres.

Operatively, the belt 11 exiting from the drive pulley 6 is received by the motion deviation pulley 7a or 7b (depending on the direction of rotation of the pulley 6) and directed to the driven pulley 8. The belt 11 exiting from the latter is then received by the other deviation pulley 7b or 7a and directed to the drive pulley 6, the pulleys 7a and 7b are thus intended for rotating in the opposite direction.

In operation, the rotation imparted by the crew member/s to the drive pulley 6 through the handles 5 is transmitted to the driven pulley 8 through the motion deviation pulley 7a and 7b. The rotation of the driven pulley 8 activates the winch rotation, thus achieving the pull of the rope wound thereon.

In an alternative embodiment, not shown, the motion deviation pulleys 7a and 7b are not coaxial, but have rotational axes parallel and tilted with respect to the X-X axis by a predetermined angle other than 90°, so as to allow the motion transmission to a winch located, with respect to the pedestal 2, closer to the fore or aft of the boat.

In a further alternative embodiment (not shown) of the transmission system of the present invention, the motion deviation pulleys 7a and 7b may be replaced by a service pulley. The motion transmission system provides, in such an instance, for the use of two different belts, the one intended for the transmission of the motion inside the pedestal and the other one intended for the transmission of the motion from the pedestal to the driven pulley Essentially, the service pulley is intended for transmitting the motion from the motion transmission system inside the pedestal to the motion transmission system between the pedestal and the driven pulley. The service pulley will then have an axial thickness sufficient for housing, at a first end thereof, the motion transmission belt inside the pedestal and, at a second end thereof, the motion transmission belt between the pedestal and the driven pulley.

The service pulley may have a Y-Y rotational axis substantially perpendicular to the X-X axis or tilted with respect to it by a predetermined angle other than 90°.

The service pulley may be replaced by a pair of service pulleys, coaxial and fixed the one to the other, each one intended for receiving one of the two above indicated transmission belts.

In the preferred embodiment of the present invention, however, the two above indicated belts are parts of a single belt, according to what above described.

The above description will have an analogous application in case the pedestal 2 is intended for controlling two winches arranged on opposite sides with respect to the pedestal itself. In this instance, a second system is provided, which is absolutely analogous and specular to that above described, intended for transmitting the motion to the second winch (with the same or with a different gear reduction ratio with respect to the motion transmission system to the first winch). In particular, the motion transmission system to the second winch comprises a second drive pulley, housed in the pedestal 2 coaxially to the driven pulley 5, a driven pulley intended to be mounted coaxially to the second winch primary rotational shaft, a single belt between the second drive pulley and the second driven pulley and a further pair of motion deviation pulleys between the second drive pulley and the second driven pulley. The actuation of the first or second drive pulley or of both, may be controlled by the crew member(s) in a conventional way (for example by means of on-off buttons located onto the handles of the pedestal).

As far as the structural and functional features of the components intended for the motion transmission to the second winch, reference shall be made to the description of the components of the motion transmission system to the first winch, such components being absolutely analogous.

1. A system for the transmission of motion to a winch for sailboats through a pedestal, comprising:
a drive pulley housed in a pedestal and having an X-X rotational axis;
a driven pulley intended to be coaxially mounted to a primary rotational shaft of a winch;
a single belt between the drive pulley and the driven pulley;
motion deviation means between the drive pulley and the driven pulley.

2. A system according to claim 1, wherein the motion deviation means is housed in the pedestal at a supporting base thereof.

3. A system according to claim 1, wherein the deviation means comprises a pair of motion deviation pulleys intended to direct the belt towards the driven pulley and towards the drive pulley, respectively.

4. A system according to claim 3, wherein the pulleys of said pair of motion deviation pulleys are coaxial and have a Y-Y rotational axis substantially perpendicular to the X-X axis.

5. A system according to claim 3, wherein the pulleys of said pair of motion deviation pulleys have parallel rotational axis, which are tilted with respect to X-X axis by a predetermined angle other than 90°.

6. A system according to claim 1, wherein said single belt is a cog belt made of plastic material with reinforcing fibres.

7. A system for the transmission of motion to a winch for sailboats through a pedestal, comprising first belt transmission means housed in a pedestal, characterised in that it comprises second belt transmission means between the pedestal and a winch, wherein said second belt transmission means is operatively connected to said first belt transmission means.

8. A system according to claim 7, wherein said first belt transmission means comprises:
a drive pulley having an X-X rotational axis;
a service pulley, intended to deviate the motion towards the winch;
a first belt between the drive pulley and the service pulley,
and wherein said second belt transmission means comprises:
said service pulley;
a driven pulley intended to be coaxially mounted onto a primary rotational shaft of a winch;
a second belt between the service pulley and the driven pulley.

9. A system according to claim 8, wherein said service pulley has a Y-Y rotational axis substantially perpendicular to the X-X axis.

10. A system according to claim 8, wherein said service pulley has a Y-Y rotational axis, which is tilted with respect to X-X axis by a predetermined angle other than 90°.

11. A system according to claim 8, wherein said first and second belt are parts of a single belt.

12. A system according to claim 11, wherein said single belt is a cog belt made of plastic material with reinforcing fibres.

13. A system for the transmission of motion to two winches through a single pedestal, comprising:
a pair of drive pulleys coaxially housed in a pedestal along a X-X rotational axis;
a pair of driven pulleys, each one intended to be located onto the boat on opposite sides with respect to the pedestal and coaxially to a primary rotational shaft of a winch;
a single belt between each drive pulley and each driven pulley;
motion deviation means between each drive pulley and each driven pulley.
